(19) United States
(12) Patent Application Publication
(10) Pub. No.: US 2006/0083431 A1
(43) Pub. Date: Apr. 20, 2006

(54) Electronic device and method for visual text interpretation

(76) Inventor: Harry M. Bliss, Evanston, IL (US)

Correspondence Address: MOTOROLA, INC., 1303 EAST ALGONQUIN ROAD, IL01/3RD, SCHAUMBURG, IL, 60196, US

(21) Appl. No.: 10/969,372

(22) Filed: Oct. 20, 2004

(51) Int. Cl. G06K 9/72

(52) U.S. Cl. 382/229

(57) ABSTRACT

An electronic device (700) captures an image (105, 725) that includes textual information having captured words that are organized in a captured arrangement. The electronic device performs optical character recognition (OCR) (110, 730) in a portion of the image to form a collection of recognized words that are organized in the captured arrangement. The electronic device selects a most likely domain (115, 735) from a plurality of domains, each domain having an associated set of domain arrangements, each domain arrangement comprising a set of feature structures and relationship rules. The electronic device forms a structured collection of feature structures (120, 740) from the set of domain arrangements that substantially matches the captured arrangement. The electronic device organizes the collection of recognized words (125, 745) according to the structured collection of feature structures into structured domain information. The electronic device uses the structured domain information (130) in an application that is specific to the domain (750-760).

### FIELD OF THE INVENTION

This invention is generally in the area of language translation, and more specifically, in the area of visual text interpretation.

### BACKGROUND

Portable electronic devices such as cellular phones are readily available that include a camera, and other conventional devices include scanning capabilities. Optical character recognition (OCR) functions are well known that can render text interpretation of the images captured by such devices. However, the use of such “OCR'd” text by applications such as language translators or dietary guidance tools within such devices can be imperfect when the text comprises lists of words, or single words, and the results displayed by such devices can be either uncommon translations, incorrect translations or presented in a manner that is hard to understand. The results can be incorrect because without additional information being entered by the user, short phrases such as one or two words can easily be misinterpreted by an application. The results can be hard to understand when the output format bears little relationship to the input format.

### BRIEF DESCRIPTION OF THE DRAWINGS

The present invention is illustrated by way of example and not limitation in the accompanying figures, in which like references indicate similar elements, and in which:

FIG. 1 is a flow chart that shows some steps of a method used in an electronic device for visual text interpretation, in accordance with some embodiments of the present invention;

FIG. 2 is a rendering of image of an example menu fragment, in accordance with some embodiments of the present invention;

FIG. 3 is a block diagram of an exemplary domain arrangement, in accordance with some embodiments of the present invention;

FIG. 4 is a block diagram of exemplary structured domain information, in accordance with some embodiments of the present invention;

FIG. 5 is a rendering of a presentation of an exemplary translated menu fragment on a display of the electronic device, in accordance with some embodiments of the present invention;

FIG. 6 is a rendering of a presentation of an exemplary captured menu fragment on a display of the electronic device, in accordance with some embodiments of the present invention; and

FIG. 7 is a block diagram of the electronic device that performs text interpretation, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

The present invention simplifies the interaction of a user with an electronic device that is used for visual text interpretation and improves the quality of the visual text interpretation.

Before describing in detail the particular apparatus and method for visual text interpretation in accordance with the present invention, it should be observed that the present invention resides primarily in combinations of method steps and apparatus components related to visual text interpretation. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

A “set” as used in this document, means a non-empty set (i.e., comprising at least one member). The term “another”, as used herein, is defined as at least a second or more. The terms “including” and/or “having”, as used herein, are defined as comprising. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

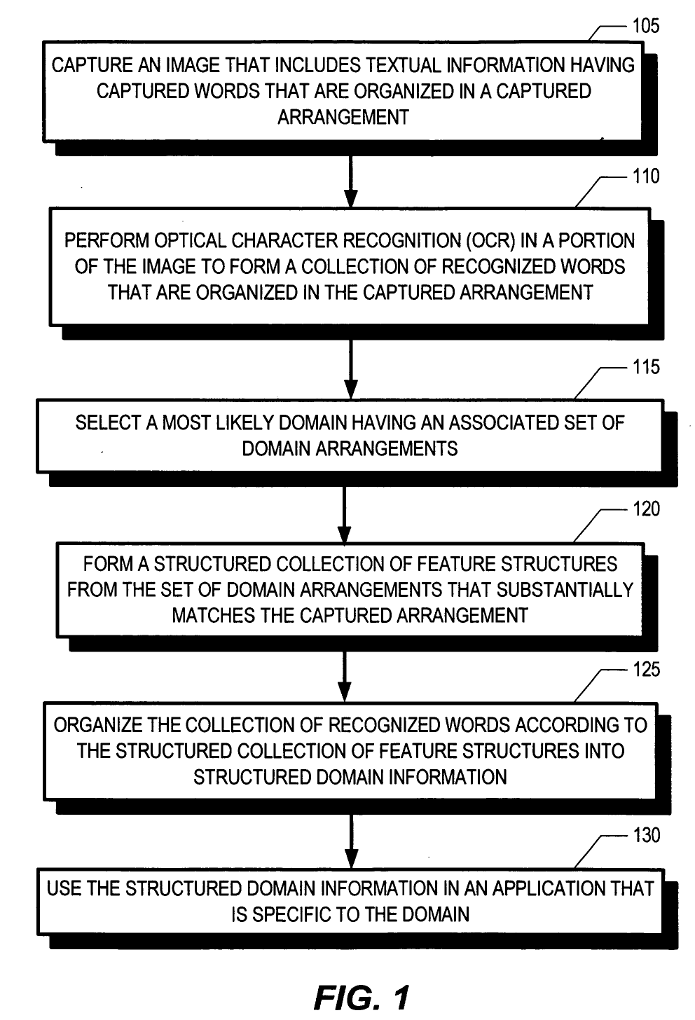

Referring now to FIG. 1, a flow chart shows some steps of a method used in an electronic device for visual text interpretation, in accordance with some embodiments of the present invention. At step 105, an image is captured that includes textual information having captured words that are organized in a captured arrangement. The image may be captured by an electronic device that may by used to help perform the visual text interpretation. The electronic device may be any electronic device capable of capturing visual text, of which just two examples are a cellular telephone and a personal digital assistant that have a camera or scanning capability.

“Captured words” means groupings of letters that may be recognized by a user as words or recognized by an optical character recognition application that may be invoked by the electronic device. “Captured arrangement” means the captured words and the orientation, format, and positional relationship of the captured words, and in general may include any formatting options such as are available in a word processing application such as Microsoft® Word, as well as other characteristics. For example, “orientation” may refer to such aspects as horizontal, vertical, or diagonal alignment of letters in a word or group of words. “Format” may include font formatting aspects, such as font size, font boldness, font underlining, font shadowing, font color, font outlining, etc., and also may include such things as word or phrase separation devices such as boxes, background color, or lines of asterisks that isolate or separate a word from another word or group of words, or groups of words from one another, and may include the use of special characters or character arrangements within a word or phrase. Examples of special characters or character arrangements within a word include, but are no means limited to the use of monetary designators (e.g., $) or alphanumeric combinations (e.g., “tspn.”). “Positional relationship” may refer to such things as the center alignment of a word or group of words with reference to another word or group of words that is/are, for example, left or right aligned, or justified, or the alignment of a word or group of words with reference to the media on which they are presented. The media may be paper, but may alternatively be any media from which the electronic device can capture words and their arrangement, such as a plastic menu page, news print, or an electronic display.

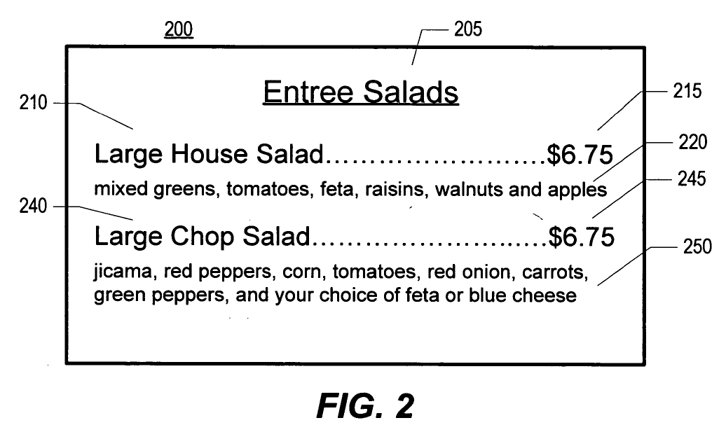

Referring to FIG. 2, a rendering of image of an example menu fragment 200 is shown, in accordance with some embodiments of the present invention. This rendering represents an image that has been captured by an electronic device. The image includes textual information that has captured words that are organized in a captured arrangement, as described above. The menu fragment includes a menu list title 205, two item names 210, 240, two item prices 215, 245, and two item ingredients lists 220, 250.

Referring again to FIG. 1, optical character recognition is performed on a portion of the image at step 110, to form a collection of recognized words that are organized in the captured arrangement. The portion may be the entire image or less than the entire image (e.g., an artistic page border may be excluded). The OCR may be performed within the electronic device, although it may alternatively be more practical in some systems or circumstances for it to be performed in another device to which the captured image is communicated (such as by wireless communication). In some embodiments, the recognized words may simply be determined as certain string sequences (i.e., character strings that occur between spaces, or between a space and a period, or a dollar sign followed numbers, commas, and a period, etc.) In other embodiments, a general dictionary for a particular language may be used to convert alphabetic strings to recognized words that are verified to have been found in the general dictionary. In accordance with the present invention, the OCR operation includes procedures that not only group letters into collections of words, but also includes procedures that determine the captured arrangement. For instance, in the example of FIG. 2, the underlining, larger font size, and relative position of the menu list title 205; the font size and relative positions of the menu items 210, 240; the use of the dollar sign combined with numeric values and the relative position of the item costs 215, 245; the line of dots connecting the menu items 210, 240 to the menu item prices 215, 245, and the relative position of the item ingredients lists 220, 250 form at least a part of the captured arrangement of the words.

At step 115, a most likely domain is selected for analyzing the captured arrangement of the collection of recognized words. The most likely domain is selected from a defined set of a plurality of supported domains. There are several ways that this may be accomplished. In one alternative, the most likely domain may be selected before step 105, such as by multimodal interaction with the user and the environment of the electronic device, and may be accomplished in some embodiments without using the captured arrangement. For example, the user may select an application that uniquely determines a domain. Examples of this are “Menu Translation” and “English to French Menu Translation”, which may be selected in two or three steps of interaction with the electronic device user. In another example, the electronic device could already be operating in a language translation mode and the user could capture an image of a business sign, such as “Lou's Pizza”, initiating a menu translation application of the electronic device. In another example, an aroma detector could determine a specific environment (e.g., bakery) in which the electronic device is most likely being used. Thus in some of these examples, step 115 may occur before step 105 or step 110. In some embodiments, the captured arrangement of the collection of organized words may be used, with or without additional input from the user of the electronic device, to select the most likely domain. For example, when the electronic device is used to capture a portion of a stock listing, the captured arrangement of the collection of recognized words may be sufficiently unique that the electronic device can select the most likely domain as a stock market listing, without using a general dictionary for word recognition. In this example, the captured arrangement may involve the recognition of capitalized three character alphabetic sequences preceded and followed by other numbers and letters that meet certain criteria (e.g., a decimal number to the right of the capitalized alphabetic sequence, a maximum number of alphanumeric characters in a line, etc.) This is an example of pattern matching. On the other hand, a word recognized using a general dictionary, such as the “Menu” in FIG. 2 may be sufficiently unique that the electronic device can select the most likely domain without using other aspects of the captured arrangement, such as relative word positions.

In another example, the captured arrangement may be used to aid or completely accomplish the selection of the most likely domain by using a domain dictionary that may associate a set of words with each domain in the set of supported domains. In the case in which sets of words associated with each domain include more than one word, a measurement of an amount of matching of the recognized words to each set of words can, for example, be used to select a most likely domain. As described in more detail below, a domain may include a set of domain arrangements, and the arrangements for all domains may be used to determine the most likely domain by searching for an exact or closest arrangement. In yet another example, the most likely domain is selected using geographic location information that is acquired by the electronic device as input to a domain location data base stored in the electronic device. For example, a GPS receiver may be a portion of the electronic device and provide geographic information that can be used with a database of retail establishments (or locations within large retail establishments) which are each related to a specific domain, or a small list of domains from which the user can select the most likely domain).

Each domain in the set of domains from which the most likely domain is selected comprises an associated set of domain arrangements that may be used to form a structured collection of feature structures to most closely match a captured arrangement.

It will be appreciated that an automatic selection of the most likely domain may involve assigning statistical uncertainties to the domain arrangements that are tested and selecting a domain from ranked sets of possible domain arrangements. For example, items in the captured arrangement, such as recognized words, patterns, sounds, commands, etc., may have a statistical uncertainty attributed to them when they are recognized, and a statistical uncertainty may also be assigned to a measure of how well the captured arrangement matches an arrangement of a domain. Such uncertainties can be combined to generate an overall uncertainty for an arrangement.

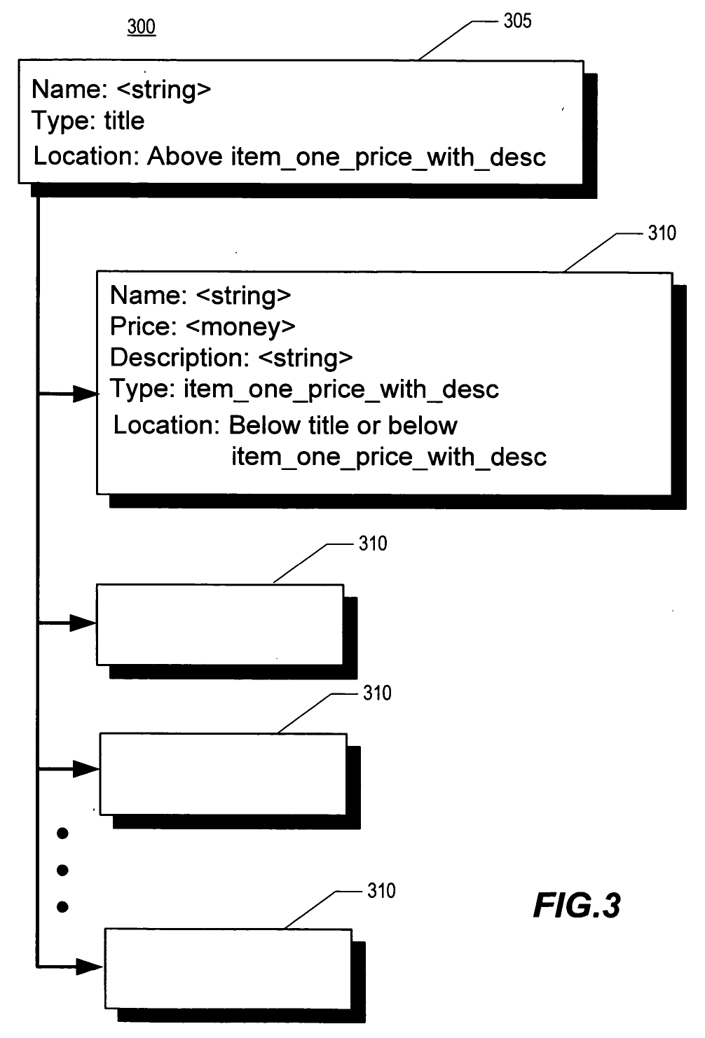

Referring to FIG. 3, a block diagram of an exemplary domain arrangement 300 is shown, in accordance with some embodiments of the present invention. The domain arrangement 300 comprises two typed feature structures and relationship rules for the typed feature structures. In general, a domain arr comprise any number of typed feature structures, which are hereafter referred to simply as feature structures, and relationship rules for them. In general, the feature structures used in domain arrangements may include a wide variety of features and relationship rules. One example of a teaching of feature structures and relationship rules is “Implementing Typed Feature Structure Grammars” by Ann Copestake, CLSI Publications, Stanford, Calif., 2002, with some relevant aspects particularly described in Section 3.3.

The two types of feature structures in this example are a menu list title feature structure 305 and one or more menu item feature structures 310 that are structured to the menu list title feature structure 305 in a hierarchy, as indicated by the lines and arrows connecting the feature structures. The feature structures 305, 310 shown in the example each comprise a name and some other features. Features that would be useful for menu items in the example described above with reference to FIG. 2 are price, description, type, and relative location. Some features may be identified as being required while others may be optional. Some feature structures may be optional. This aspect is not illustrated in FIG. 3, but for example the “Name” in the menu list title feature set 305 may be required, whereas the relative location may not be required. In some domains, the required relative location may be indicated by the hierarchy of the set feature structures in the domain arrangement (as indicated by the lines and arrows),so that, in the example being discussed, “relative location” may not need to be an item of the feature structures in the domain. Some features in a feature structure may have a set of values associated therewith, to be used for matching to items in the captured arrangement of the collection of recognized words. For example, the feature “Name” in the feature structure 305 for the menu title may have a set of acceptable title names (not shown in FIG. 3) such as “dessert”, “main course”, “salad”, etc., which can be matched with recognized words.

Referring again to FIG. 1, a structured collection of feature structures is formed at step 120 from the set of domain arrangements. The structured collection of feature structures substantially matches the captured arrangement of the collection of recognized words. This may be accomplished by comparing the recognized words and captured arrangement to feature structures of the domain arrangements in the set of associated domain arrangements, to find a closest match or a plurality of closest matches. In one example, this may be done by forming a weighted value for each domain arrangement which is based on a high weight for a captured feature that exactly matches a required feature of a feature structure of a domain arrangement, and lower weights for instances in which the captured feature partially matches a required feature or for which a captured feature matches a non-required feature. Other weighting arrangements may be used. In some embodiments, the domain arrangements may be sufficiently different and have enough required features that they are mutually exclusive, so that if a match with some portion of the captured arrangement is found with one of them, the search may be ended for that portion of the captured arrangement.

When one or more domain arrangements have been found to closely match the captured arrangement, they may be used to form the structured collection of feature structures. In many instances the structured collection can be formed from one domain arrangement.

Referring again to FIG. 1, the collection of recognized words is organized according to the structured collection of feature structures, into structured domain information. In other words, the recognized words have been entered into specific instances of the feature structures of the sets of domain arrangements. Some aspects of the captured arrangements may not be included in the information stored in the feature structures, even though they may be important for determining the most likely domain or for forming the structured collection of feature structures. For example, it may not be necessary to store font color, or font outlining in a feature structure.

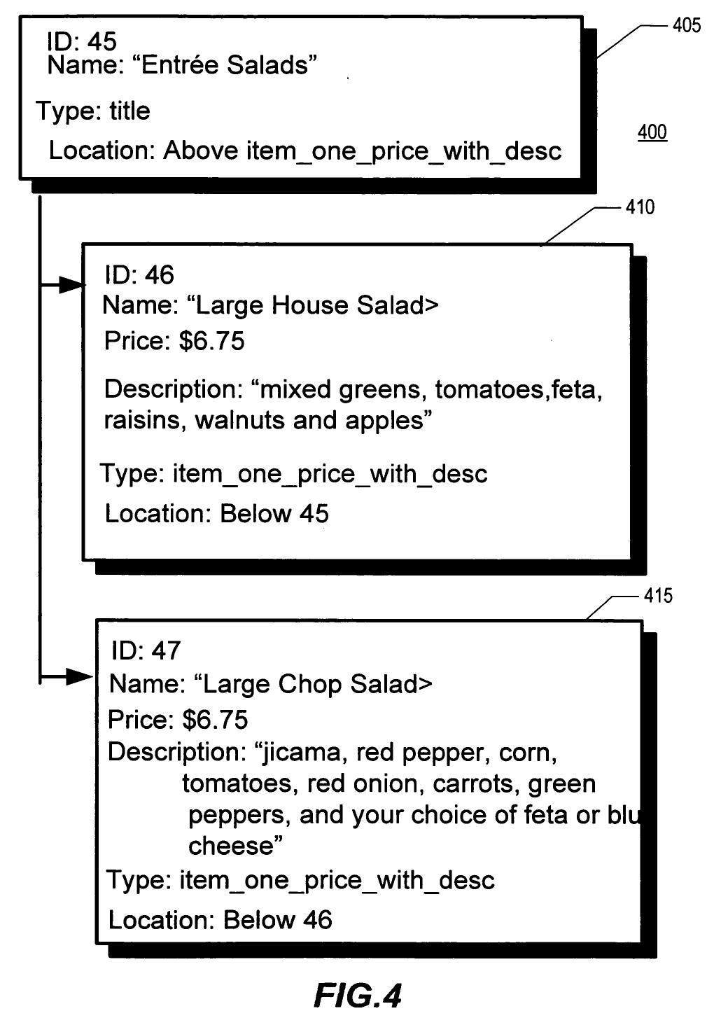

Referring to FIG. 4, a block diagram of exemplary structured domain information 400 is shown, in accordance with some embodiments of the present invention. The structured domain information 400 in this example is obtained from the arrangement of recognized words captured from the image 200 (FIG. 2). In this instance, the structured collection of feature structures included only the one domain arrangement 300, which is used to organize the collection of recognized words into the structured domain information 400 comprising an instantiated menu title feature structure 405 and two instantiated item_one_price_with_desc feature structures 410. The instantiated feature structures are given unique identification numbers (IDs) for non-ambiguous referencing, and the ID numbers are used to define a relative location of the features described in the feature structures. For example, the item feature structure 410 in FIG. 4 has a location feature having value “Below 45”, indicating that it is located below feature structure 405 in FIG. 4 having ID 45, which is a title feature structure.

Referring again to FIG. 1, the structured domain information may be used in an application that is specific to the domain. This means that the information supplied as an input to the application includes the domain type and the structured domain information, or that the application is selected based on the domain type and supplied the structured domain information. The application then processes the structured domain information, and typically presents information to the user related to the captured information. The application may be domain specific simply in the aspect of being able to accept and use the structured domain information properly, but may be further domain specific in how it uses the structured domain information.

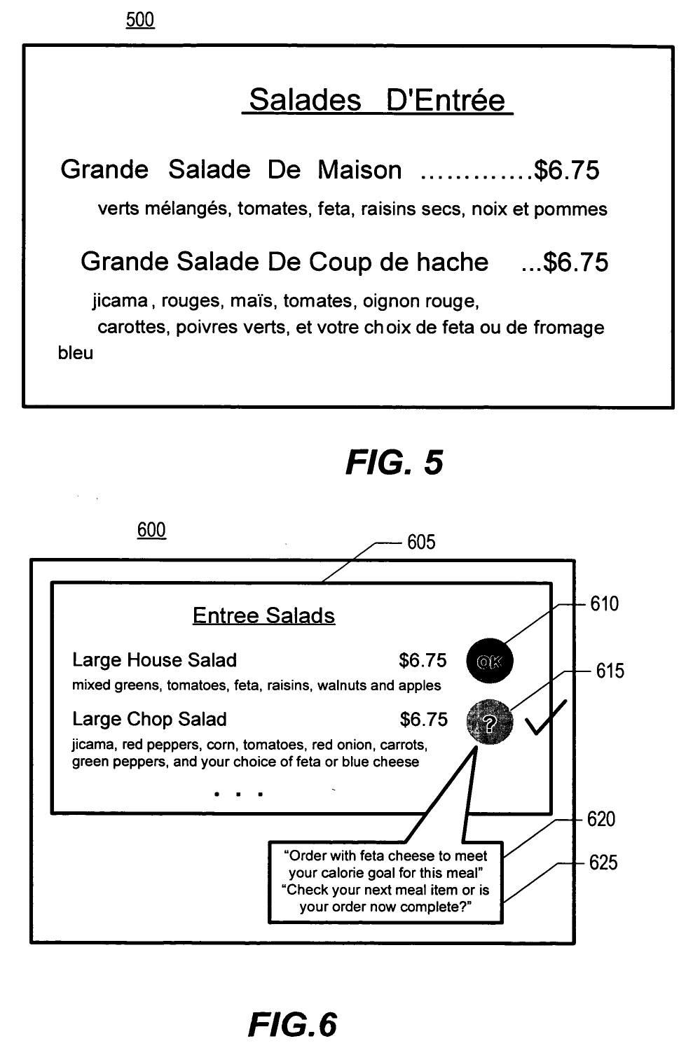

Referring to FIG. 5, a rendering of a presentation of an exemplary translated menu fragment on a display 500 of the electronic device is shown, in accordance with some embodiments of the present invention. This rendering represents an image that is being presented on a display of an electronic device under control of an English-French menu translation application. The image generated by this example of an application specific to a domain is generated in response to the exemplary structured domain information 400 generated at step 125 (FIG. 1). This exemplary application accepts the structured domain information, uses a domain specific English to French menu machine translator, to translate the words to French, and presents the translated information in an arrangement topographically similar to (and derived from) the captured arrangement. The similarity may be extended to refined features such as font color, background color, but may need not be. Generally, greater similarity provides a better user experience.

It will be appreciated that the use of a domain specific English to French menu translation dictionary (which is one example of a domain specific machine translator) may provide a better translation (and be smaller) than a generic English to French menu machine translator. In the example shown in FIG. 5, for example, “red peppers” has been translated to “rouges which would normally be used in a French menu”, rather than “poivrons rouges”, which might result from using a generic English to French machine translator.

In this example, a user whose native language is French, and who does not understand English well, will be presented a menu in a natural arrangement using familiar French terms.

In some embodiments of the present invention, a domain specific machine translator may translate icons that are used in a first language to different icons in a second language that is different, but which may better represent the information to a person fluent in the second language. For example, a Stop sign may have an appearance or icon in an Asian country that is different than the one typically used in North America, so a substitution could be appropriate. This need may be more evident for icons other than traffic signals but may diminish as global internet usage continues to expand.

The domain specific application described above with reference to FIG. 5 may provide further valuable features. For example, the application may allow the user to select a desired item (or several desired items in a more complete menu) in the translated language (French, in this example) using a multimodal dialog manager, and the application could then identify those items on a display presentation of the captured image 200, such as with arrows superimposed on the presentation of the captured image 200, thus allowing the user to show the captured image with selected items pointed out to a waiter, allowing non-ambiguous communication between two users who do not understand each other's language, in a very natural manner. Alternatively, the selected portion of the captured words could be presented to the waiter using a voice synthesis output function of the electronic device. In a related example, a waiter may indicate a recommended menu item on the English menu by pointing to the recommended item, which the French speaking user may then select (for example by using normal word processing selection commands) using a presentation on the display of the captured (English) arrangement for specific translation to French for presentation using the display or voice synthesis.

Referring to FIG. 6, a rendering of a presentation of an exemplary captured menu fragment on a display 605 of the electronic device is shown, in accordance with some embodiments of the present invention. This rendering represents an image that is being presented on a display of an electronic device under control of an application that is specific to a diet domain. Note that in this example, as in the example described with reference to FIG. 5, the arrangement of the captured words that are presented on the display 605 is very similar to the captured arrangement. The application in this example uses the information in the menu item feature structures and other information that has been acquired in the past, such as a type of diet the user has selected and the user's recent food intake, to make a dietary based recommendation to the user that is reflected by the icons 610, 615, and the text 620. The application then requests the user to make another choice 625. In another example, the application may determine certain nutritional contents of the menu item that are selected or deemed important to the user based on the user's type of diet and the application may list those nutritional contents in juxtaposition with the menu items, which are presented on the display 605 in very similar arrangement to the captured arrangement.

Other examples of specific domain applications are a transportation schedule application, a business card application, and a racing application. The transportation application may determine itinerary criteria from user inputs, or from a data store of user preferences, select one or more itinerary segments from the transportation schedule according to the itinerary criteria, and present the one or more of the itinerary segments on a display of an electronic device. The business card application may store portions of information on a business card into a contacts database according to the structured domain information. The device could additionally store time and location of when that card was entered, and the entry could be annotated by the user using a multimodal user interface.

The racing application may identify predicted leaders of the race from the structured domain information of the racing schedule and other data in the electronic device (such as criteria selected by the user), and present the one or more predicted leaders to the user.

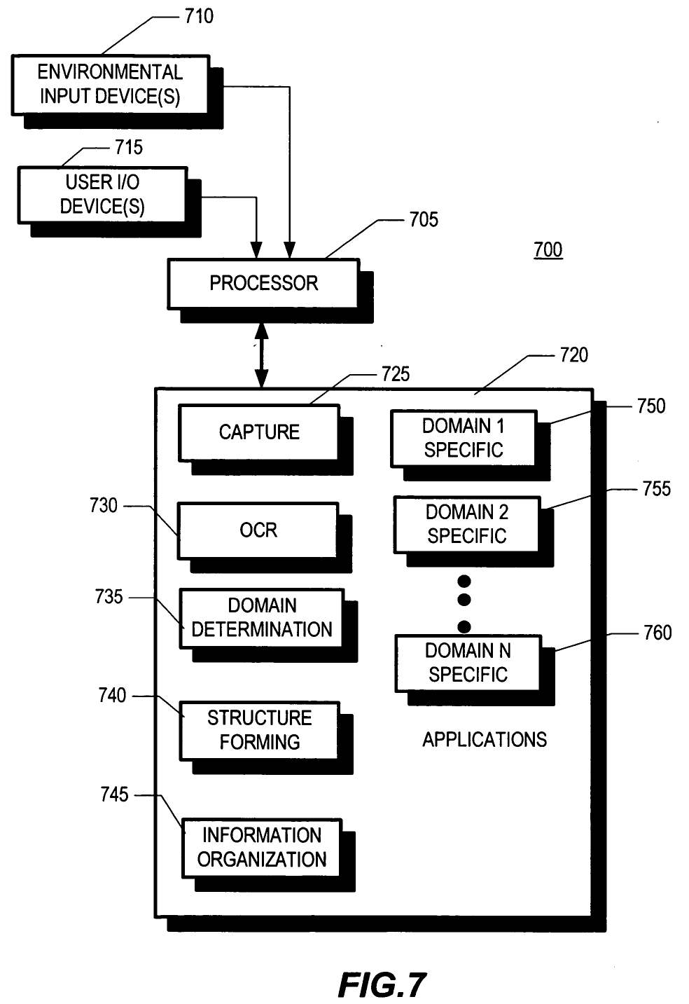

Referring to FIG. 7, a block diagram of an electronic device 700 that performs text interpretation is shown, in accordance with some embodiments of the present invention. The electronic device 700 may comprise components including a processor 705, zero or more environmental input devices 710, one or more user input devices 715, and memory 720. These components may be conventional hardware devices, but need not be. Other components and applications may also be in the electronic device 700 of which just a few examples are power conditioning components, an operating system and wireless communication components. Applications 725-760 are stored in the memory 720 and include conventional applets but also include unique combinations of software instructions (applications, functions, programs, servlets, applets, etc) designed to provide the functions described herein, above. More specifically, the capture function 725 may operate with a camera included in the environmental input devices 710 to capture the words and arrangements of the words, as described with reference to FIG. 1, step 105, and elsewhere in this document. The OCR application 730 may provide conventional optical character recognition functions and unique related functions to define captured arrangements, as described with reference to FIG. 1, step 110, and elsewhere in this document. The domain determination application 735 may provide unique functions as described with reference to FIG. 1, step 115, and elsewhere in this document. The arrangement forming application 740 may provide unique functions as described with reference to FIG. 1, step 120, and elsewhere in this document. The information organization application 740 may provide unique functions as described with reference to FIG. 1, step 125, and elsewhere in this document. The domain specific applications 750-760 represent a plurality of domain specific applications as described with reference to FIG. 1, step 130, and elsewhere in this document.

In some embodiments of the present invention, a domain selection is made from a set of domains that are called language independent domains. Examples of language independent domains are menu ordering, transportation schedule, racing tally, and grocery coupon. A single language translation mode is either predetermined in the electronic device, or is selected from a plurality of possible translation modes, such as by the user of the electronic device. The method then performs step 115 (FIG. 1) by selecting one of the language independent domains and includes steps of translating the structured domain information into translated words of a second language using a domain specific machine translator of the second language and presenting the translated words, visually, using the captured arrangement. In these embodiments, the method may further include steps of identifying a user selected portion of the translated words and presenting a corresponding portion of the captured words that correspond to the user selected portion of the translated words.

It will be appreciated that the means and method described above support customizing of machine translation to small domains, to improve the reliability of the translation, and that it provides a means of word sense disambiguation in machine translation by identifying a domain that may be a small domain, and by providing domain specific semantic “tags” (e.g., the features of the feature structures). It will be further appreciated that the determination of the domain may be accomplished in a multimodal manner, using inputs made by the user, for example, from a keyboard or a microphone, and/or inputs from the environment using such devices as a camera, a microphone, a GPS device, or aroma sensor, and/or historical information concerning the user's recent actions and choices.

It will be appreciated the text interpretation means and methods described herein may be comprised of one or more conventional processors and unique stored program instructions operating within an electronic device that also comprises user and environmental input/output components. The unique stored program instructions control the one or more processors to implement, in conjunction with certain non-processor circuits, some, most, or all of the functions of the electronic device described herein. The non-processor circuits may include, but are not limited to, a radio receiver, a radio transmitter, signal drivers, clock circuits, power source circuits, user input devices, user output devices, and environmental input devices. As such, these functions may be interpreted as steps of the method to perform the text interpretation. Alternatively, some or all functions could be implemented by a state machine that has no stored program instructions, in which each function or some combinations of certain of the functions are implemented as custom logic. Of course, a combination of the two approaches could be used. Thus, methods and means for these functions have been described herein.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method used in an electronic device for visual text interpretation, comprising:
capturing an image that includes textual information having captured words that are organized in a captured arrangement;
performing optical character recognition (OCR) in a portion of the image to form a collection of recognized words that are organized in the captured arrangement;
selecting a most likely domain from a plurality of domains, each domain having an associated set of domain arrangements, each domain arrangement comprising a set of feature structures and relationship rules;
forming a structured collection of feature structures from the set of domain arrangements that substantially matches the captured arrangement;
organizing the collection of recognized words according to the structured collection of feature structures into structured domain information; and
using the structured domain information in an application that is specific to the domain.

2. The method according to claim 1, wherein the captured words are in a first language, and wherein using the structured domain information comprises:
translating the structured domain information into translated words of a second language using a domain specific machine translator of the second language; and
presenting the translated words, visually, using the captured arrangement.

3. The method according to claim 2, wherein the domain specific machine translator includes icon translations, and wherein, when the image includes an icon, translating includes translating the icon into a translated icon that includes at least one of a translated image and a translated word using the domain specific machine translator of the second language, and wherein presenting includes presenting the translated words and translated icon using the captured arrangement.

4. The method according to claim 2, wherein using the structured domain information further comprises:
identifying a user selected portion of the translated words; and
presenting a corresponding portion of the captured words that correspond to the user selected portion of the translated words.

5. The method according to claim 4, wherein identifying a user selected portion of the translated words comprises interacting with the user using a multimodal dialog manager.

6. The method according to claim 4, wherein the corresponding portion of the captured words are presented using one of a text to speech synthesized presentation and a visual presentation.

7. The method according to claim 1, wherein using the structured domain information further comprises:
identifying a user selected portion of the captured arrangement;
translating a corresponding portion of the structured domain information into translated words of a second language using a domain specific machine translator of the second language; and
presenting the translated words of the corresponding portion using the structured arrangement.

8. The method according to claim 1, wherein the structured domain information includes food items, and wherein using the structured domain information comprises:
determining nutritional contents of food items in the structured domain information; and
presenting the nutritional contents for a user according to the captured arrangement.

9. The method according to claim 1, wherein the structured domain information includes a transportation schedule, and wherein using the structured domain information comprises:
determining itinerary criteria from user input;
selecting one or more itinerary segments from the transportation schedule according to the itinerary criteria; and
presenting the one or more itinerary segments.

10. The method according to claim 1, wherein the structured domain information includes information from a business card, and wherein using the structured domain information comprises:
storing portions of the information into a contacts database according to the structured domain information.

11. The method according to claim 1, wherein the structured domain information includes a racing schedule for a race, and wherein using the structured domain information comprises:
identifying predicted leaders of the race from the structured domain information of the racing schedule and other data in the electronic device; and
presenting the one or more leaders.

12. The method according to claim 1, wherein the image is acquired by one of an optical scanner or a camera that is a portion of a hand-held device.

13. The method according to claim 1, wherein the most likely domain is at least partially selected using one or more inputs from a user.

14. The method according to claim 1, wherein the most likely domain is at least partially selected using a domain dictionary and one or more words from the collection of recognized words.

15. The method according to claim 1, wherein the most likely domain is selected using geographic location information acquired by the electronic device and a domain location data base stored in the electronic device.

16. The method according to claim 1, further comprising selecting the application that is specific to the domain from a set of domain specific applications.

17. A method used in an electronic device for visual text interpretation, comprising:
capturing an image that includes textual information having captured words that are organized in a captured arrangement;
performing optical character recognition (OCR) in a portion of the image to form a collection of recognized words that are organized in the captured arrangement;
selecting a most likely domain from a plurality of language independent domains, each domain having an associated set of domain arrangements, each domain arrangement comprising a set of feature structures and relationship rules;
forming a structured collection of feature structures from the set of domain arrangements that substantially matches the captured arrangement;
organizing the collection of recognized words according to the structured collection of feature structures into structured domain information;
translating the structured domain information into translated words of a second language using a domain specific machine translator of the second language; and
presenting the translated words, visually, using the captured arrangement.

18. The method according to claim 17, further comprising:
identifying a user selected portion of the translated words; and
presenting a corresponding portion of the captured words that correspond to the user selected portion of the translated words.

19. An electronic device for visual text interpretation, comprising:
a capture means for capturing an image that includes textual information having captured words that are organized in a captured arrangement;
an optical character recognition means for performing optical character recognition (OCR) in a portion of the image to form a collection of recognized words that are organized in the captured arrangement;
a domain determination means for selecting a most likely domain from a plurality of domains, each domain having an associated set of domain arrangements, each domain arrangement comprising a set of feature structures and relationship rules;
a structure forming means for forming a structured collection of feature structures from the set of domain arrangements that substantially matches the captured arrangement;
an information organization means for organizing the collection of recognized words according to the structured collection of feature structures into structured domain information; and
a plurality of domain specific applications from which one is selected to use the structured domain information.
